(19) United States
(12) Patent Application Publication
(10) Pub. No.: US 2014/0053051 A1
(43) Pub. Date: Feb. 20, 2014

(54) APPLICATION SERVER AND METHOD FOR EDITING DRAWINGS OF WEBPAGE

(71) Applicant: HON HAI PRECISION INDUSTRY CO., LTD., New Taipei (TW)

(72) Inventors: BAO-QUAN CHEN, New Taipei (TW); CHEN-WEI HSU, New Taipei (TW)

(73) Assignee: HON HAI PRECISION INDUSTRY CO., LTD., New Taipei (TW)

(21) Appl. No.: 13/949,242

(22) Filed: Jul. 24, 2013

(30) Foreign Application Priority Data
Aug. 14, 2012 (TW) 101129278

(51) Int. Cl. G06F 3/0481

(52) U.S. Cl. CPC G06F 3/0481
USPC 715/211

(57) ABSTRACT

In a method for editing drawings of a webpage using an application server, the application server connects to at least one terminal device through a network. The application server obtains a webpage document from a storage device of the application server when a webpage access request is received from a browser of the terminal device. The application server generates a drawing editing interface according to the webpage document, and displays a webpage including the drawing editing interface on a display screen of the terminal device using the browser. The application server performs an editing operation on a drawing of the webpage through the drawing editing interface of the browser, generates basic information of elements of the drawing and connection information of the elements, and stores the basic information and the connection information of the elements into the storage device.

### BACKGROUND

1. Technical Field

Embodiments of the present disclosure relate to drawings editing systems and methods, and particularly to an application server and method for editing drawings of a webpage.

2. Description of Related Art

Networking services provide websites that help people to communicate with other people in their networks. People tend to communicate using the networking services primarily using text. However, there are times when it would be more convenient or enjoyable to communicate using drawings. Unfortunately, it is inconvenient to communicate using drawings using the networking services. For example, some networking services allow a user to upload and send drawings to other user. However, these drawings are not editable by the user of the drawings. Therefore, there is need to improve the aforementioned problems.

### BRIEF DESCRIPTION OF THE DRAWINGS

FIG. 1 is a block diagram of one embodiment of an application server including a webpage drawing editing system.

FIG. 2 is a block diagram illustrating function modules of the webpage drawing editing system included in the application server of FIG. 1.

FIG. 3 shows one exemplary embodiment of a drawing editing interface displayed on a browser of a terminal device.

FIG. 4 shows one exemplary embodiment of editing a drawing of the webpage through the drawing editing interface.

FIG. 5 shows one exemplary embodiment of zooming in and zooming out a drawing on the drawing editing interface.

FIG. 6 is a flowchart of one embodiment of a method for editing drawings of a webpage using the application device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

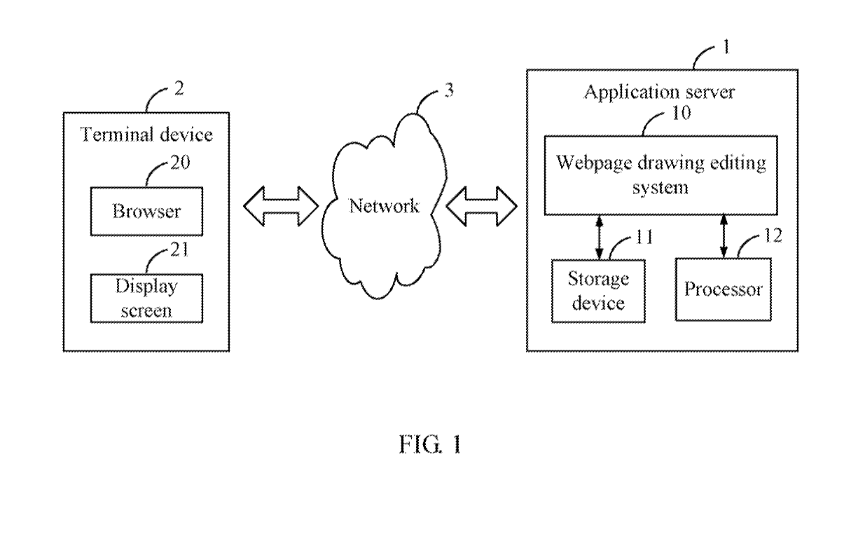

FIG. 1 is a block diagram of one embodiment of an application server 1 including a webpage drawing editing system 10. In the embodiment, the webpage drawing editing system 10 is implemented by the application server 1 which communicates with at least one terminal device 2 through a network 3. The application server 1 provides network services such as data access services and drawings editing services for the terminal device 2. The network 3 may be a wireless network such as a WIFI network, a wide area network (WAN) such as the Internet, or a local area network (LAN) such as an intranet network.

The application server 1 may further include, but is not limited to, a storage device 11 and at least one processor 12. The webpage drawing editing system 10 may include computerized instructions in the form of one or more programs that are stored in the storage device 11 and executed by the at least one processor 12. The storage device 11 stores a plurality of webpage documents composed of a webpage to be displayed on the terminal device 2. Each of the webpage documents may be a hypertext markup language (HTML) document, an extensible markup language (XML) document, or a document based on other web-based programming languages.

In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, or a data storage medium. The at least one processor 12 is a central processing unit (CPU) or microprocessor that performs various functions of the application server 1.

In one embodiment, the terminal device 2 may be a personal computer (PC), a notebook, a mobile phone, a PAD device or any other electronic device. The terminal device 2 includes, but is not limited to, a browser 20 and a display screen 21. The browser 20 sends a webpage access request to the application server 1, and parses a webpage document sent from the application server 1 to display a webpage on the display screen 21.

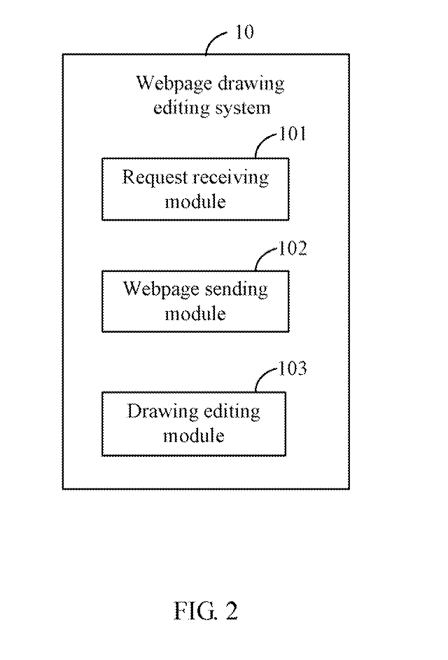

FIG. 2 is a block diagram illustrating function modules of the webpage drawing editing system 10 included in the application server 1. In the embodiment, the webpage drawing editing system 10 includes a request receiving module 101, a webpage sending module 102, and a drawing editing module 103. The modules 101-103 may comprise computerized instructions in the form of one or more programs that are stored in the storage device 11 and executed by the at least one processor 12.

The request receiving module 101 obtains a webpage document from the storage device 11 when a webpage access request is received from the browser 20 of the terminal device 2. The request receiving module 101 further determines whether the webpage document includes a drawing editing identifier. In the embodiment, the editing identifier may be predefined in the webpage document, and indicates whether a drawing of the webpage is editable by a user of the terminal device 2.

The webpage sending module 102 generates a drawing editing interface when the webpage document includes the drawing editing identifier, sends the webpage document to the terminal device 2, and displays a webpage including the drawing editing interface on the display screen 21 using the browser 20. In the embodiment, the browser 20 parses the webpage document to generate a webpage including the drawing editing interface when the terminal device 2 receives the webpage document sent from the application server 1, and displays the webpage including the drawing editing interface on the browser 20 of the terminal device 2.

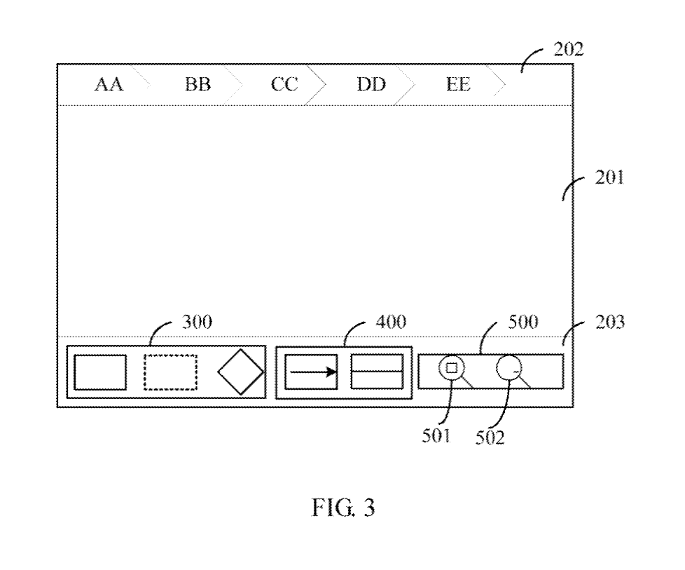

FIG. 3 shows one exemplary embodiment of the drawing editing interface displayed on the browser 21 of the terminal device 2. In the embodiment, the drawing editing interface includes a drawing editing area 201, a drawing marking area 202, and a toolbar 203. The user can draw and edit drawings on the drawing editing area 201, and mark each of the drawings with a drawing tag on the drawing marking area 202. The drawing marking area 202 is divided into a plurality of sub marking areas, and each sub marking areas corresponds to a drawing tag, such as “AA” tag, “BB” tag, “CC” tag, or “DD” tag, for example.

The toolbar 203 includes an element selecting tool 300, an element connecting tool 400 and a zoom-in or zoom-out tool 500. The element selecting tool 300 includes a plurality of elements for editing the drawings of the webpage, such as such as points, lines, angles, planes and circles. The element connecting tool 400 includes various types of lines, such as a left arrow line, a right arrow line, and a bidirectional arrow line. The zoom-in or zoom-out tool 500 includes a zoom-in button 501 and a zoom-out button 502. The zoom-in button 501 makes a drawing zoom in, and the zoom-out button 501 makes a drawing zoom out.

The drawing editing module 103 performs an editing operation on a drawing of the webpage when the user edits the drawing on the drawing editing interface through the browser 20 of the terminal device 2, generates basic information of elements of the drawing and connection information of each of the elements, and stores the basic information and the connection information of each of the elements into the storage device 11. In the embodiment, the webpage may include one or more drawings, and each of the drawings may include a plurality of elements such as points, lines, angles, planes and circles. The basic information of each of the elements may include a shape of the element, a size of the element, a location of the element, a name of the element, and description information of the element. The connection information of each of the elements indicates a connection relationship between each of the elements.

In the embodiment, the drawing editing module 103 performs the editing operation on the drawing of the webpage by changing a cascading style sheet (CSS) format of the elements of the drawing to present on the webpage and displaying all the elements of the drawing on the browser 20. In the embodiment, the editing operation may include adding elements to the drawing, moving elements of the drawing, zooming in or zooming out elements of the drawing, deleting elements from the drawing, adding a connecting line of each element, and deleting a connecting line from the elements.

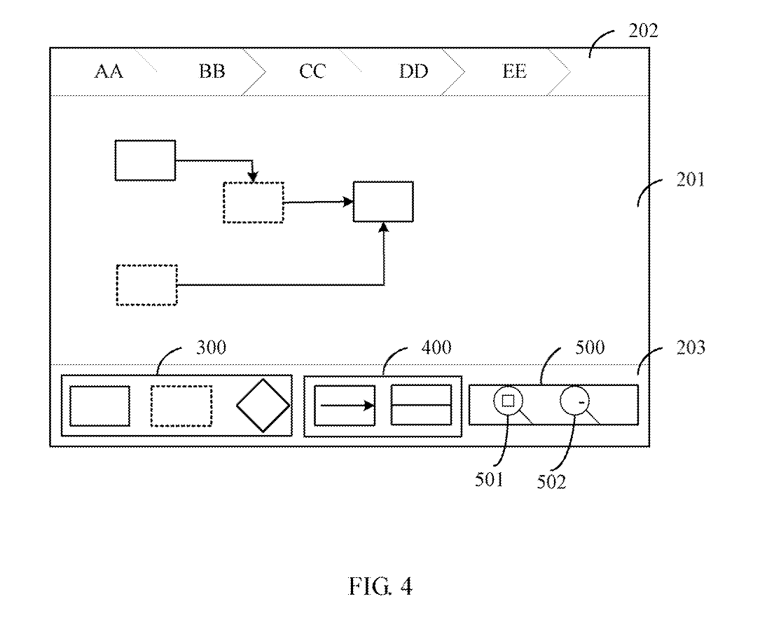

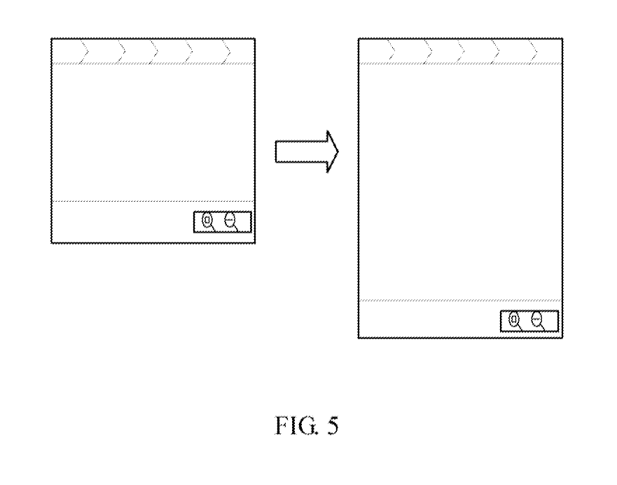

FIG. 4 shows one exemplary embodiment of editing a drawing of the webpage through the drawing editing interface. In the example, four elements (e.g., four rectangle blocks) are selected from the element selecting tool 300 to construct a drawing on the drawing editing area 201, and three arrow lines are selected from the element connecting tool 400 to connect each of the elements of the drawing. During the process of the drawing on the drawing editing area 201, the drawing editing area 201 can be zoomed in when the zoom-in button 501 is clicked or can be zoomed out when the zoom-out button 502 is clicked. FIG. 5 shows one exemplary embodiment of zooming in and zooming out the drawing on the drawing editing interface. In the embodiment, the user can edit the drawing of the webpage on the drawing editing interface through the browser 20 of the terminal device 2.

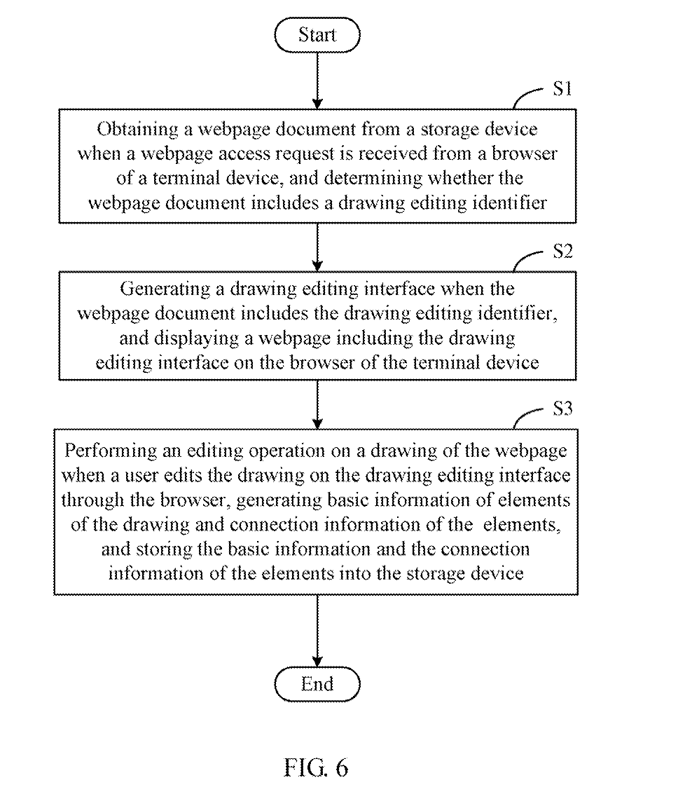

FIG. 6 is a flowchart of one embodiment of a method for editing drawings of a webpage using the application device 1. The method is performed by execution of computer-readable program codes or instructions by the at least one processor 12 of the application device 1. The user can edit a drawing of the webpage through the browser 20 of the terminal device 2. Depending on the embodiment, additional steps may be added, others removed, and the ordering of the steps may be changed.

In block S1, the request receiving module 101 obtains a webpage document from the storage device 11 when a webpage access request is received from the browser 20 of the terminal device 2, and determines whether the webpage document includes a drawing editing identifier. In the embodiment, the editing identifier may be predefined in the webpage document, and indicates whether drawings of the webpage is editable by a user of the terminal device 2.

In block S2, the webpage sending module 102 generates a drawing editing interface when the webpage document includes the drawing editing identifier, sends the webpage document to the terminal device 2, and displays a webpage including the drawing editing interface on the display screen 21 using the browser 20. In the embodiment, the browser 20 parses the webpage document to generate a webpage including the drawing editing interface when the terminal device 2 receives the webpage document sent from the application server 1, and displays the webpage including the drawing editing interface on the browser 20 of the terminal device 2.

In block S3, the drawing editing module 103 performs an editing operation on a drawing of the webpage when the user edits the drawing on the drawing editing interface through the browser 20 of the terminal device 2, generates basic information of elements of the drawing and connection information of each of the elements, and stores the basic information and the connection information of each of the elements into the storage device 11. As discussed above, the drawing may include a plurality of elements such as points, lines, angles, planes and circles. The editing operation may include adding elements to the drawing, moving elements of the drawing, zooming in or zooming out elements of the drawing, deleting elements from the drawing, adding a connecting line of each element, and deleting a connecting line from the elements.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An application server being connected to at least one terminal device through a network, the application server comprising:
at least one processor; and
a storage device storing one or more computer-readable program instructions, which when executed by the at least one processor, causes the at least one processor to:
obtain a webpage document from the storage device when a webpage access request is received from a browser of the terminal device;
generate a drawing editing interface according to the webpage document, and display a webpage including the drawing editing interface on a display screen of the terminal device using the browser; and
perform an editing operation on a drawing of the webpage through the drawing editing interface of the browser, generate basic information of elements of the drawing and connection information of the elements, and store the basic information and the connection information of the elements into the storage device.

2. The application server according to claim 1, wherein the program instructions further cause the processor to determine whether the webpage document includes a drawing editing identifier that is predefined in the webpage document, and indicates whether a drawing of the webpage is user-editable.

3. The application server according to claim 1, wherein the drawing of the webpage is edited by changing a cascading style sheet (CSS) format of each element of the drawing to present on the webpage, and displaying the changed elements of the drawing on the browser.

4. The application server according to claim 1, wherein the basic information of each element comprise a shape of the element, a size of the element, a location of the element, a name of the element, and description information of the element, and the connection information of each the element indicates a connection relationship between each of the elements.

5. The application server according to claim 1, wherein the drawing editing interface comprises a drawing editing area, a drawing marking area, and a toolbar that includes an element selecting tool, an element connecting tool and a zoom-in or zoom-out tool.

6. The application server according to claim 5, wherein the editing operation comprises:
selecting one or more elements from the element selecting tool to construct the drawing on the drawing editing area;
drawing a connection between each of the elements using an arrow line that is selected from the element connecting tool; and
zooming in or zooming out the drawing presented on the drawing editing area using the zoom-in or zoom-out tool.

7. A method for editing drawings of a webpage using an application server, the application server being connected to at least one terminal device through a network, the method comprising:
obtaining a webpage document from a storage device of the application server when a webpage access request is received from a browser of the terminal device;
generating a drawing editing interface according to the webpage document, and displaying a webpage including the drawing editing interface on a display screen of the terminal device using the browser; and
performing an editing operation on a drawing of the webpage through the drawing editing interface of the browser, generating basic information of elements of the drawing and connection information of the elements, and storing the basic information and the connection information of the elements into the storage device.

8. The method according to claim 7, further comprising:
determining whether the webpage document includes a drawing editing identifier that is predefined in the webpage document and indicates whether a drawing of the webpage is user-editable.

9. The method according to claim 7, wherein the drawing of the webpage is edited by changing a cascading style sheet (CSS) format of each of the elements of the drawing to present on the webpage, and displaying the changed elements of the drawing on the browser.

10. The method according to claim 7, wherein the basic information of each of the elements comprise a shape of the element, a size of the element, a location of the element, a name of the element, and description information of the element, and the connection information of each of the elements indicates a connection relationship between each of the elements.

11. The method according to claim 7, wherein the drawing editing interface comprises a drawing editing area, a drawing marking area, and a toolbar that includes an element selecting tool, an element connecting tool and a zoom-in or zoom-out tool.

12. The method according to claim 11, wherein the editing operation comprises:
selecting one or more elements from the element selecting tool to construct the drawing on the drawing editing area;
drawing a connection between each of the elements using an arrow line that is selected from the element connecting tool; and
zooming in or zooming out the drawing presented on the drawing editing area using the zoom-in or zoom-out tool.

13. A non-transitory storage medium having stored thereon instructions that, when executed by at least one processor of an application server, cause the application server to perform a method for editing drawings of a webpage, the application server being connected to at least one terminal device through a network, the method comprising:
obtaining a webpage document from a storage device of the application server when a webpage access request is received from a browser of the terminal device;
generating a drawing editing interface according to the webpage document, and displaying a webpage including the drawing editing interface on a display screen of the terminal device using the browser; and
performing an editing operation on a drawing of the webpage through the drawing editing interface of the browser, generating basic information of elements of the drawing and connection information of the elements, and storing the basic information and the connection information of the elements into the storage device.

14. The storage medium according to claim 13, wherein the method further comprises:
determining whether the webpage document includes a drawing editing identifier that is predefined in the webpage document and indicates whether a drawing of the webpage is user-editable.

15. The storage medium according to claim 13, wherein the drawing of the webpage is edited by changing a cascading style sheet (CSS) format of each of the elements of the drawing to present on the webpage, and displaying the changed elements of the drawing on the browser.

16. The storage medium according to claim 13, wherein the basic information of each of the elements comprise a shape of the element, a size of the element, a location of the element, a name of the element, and description information of the element, and the connection information of each of the elements indicates a connection relationship between each of the elements.

17. The storage medium according to claim 13, wherein the drawing editing interface comprises a drawing editing area, a drawing marking area, and a toolbar that includes an element selecting tool, an element connecting tool and a zoom-in or zoom-out tool.

18. The storage medium according to claim 17, wherein the editing operation comprises:
selecting one or more elements from the element selecting tool to construct the drawing on the drawing editing area;
drawing a connection between each of the elements using an arrow line that is selected from the element connecting tool; and
zooming in or zooming out the drawing presented on the drawing editing area using the zoom-in or zoom-out tool.
